(19) United States
(12) Patent Application Publication
(10) Pub. No.: US 2007/0003755 A1
(43) Pub. Date: Jan. 4, 2007

(54) Poly(arylene ether)/polyamide composition

(76) Inventors: Andrew Paul Korzen, Selkirk, NY (US); Sai-Pei Ting, Slingerlands, NY (US)

Correspondence Address: CANTOR COLBURN, LLP, 55 GRIFFIN ROAD SOUTH, BLOOMFIELD, CT, 06002, US

(21) Appl. No.: 11/169,606

(22) Filed: Jun. 29, 2005

(51) Int. Cl. B32B 27/34; B32B 27/20

(52) U.S. Cl. 428/332; 428/474.4

(57) ABSTRACT

A coated article comprises a powder coating disposed on at least a portion of a substrate wherein the substrate comprises: a compatibilized blend of a poly(arylene ether) and a polyamide; an electrically conductive filler; and an impact modifier.

### BACKGROUND OF INVENTION

This disclosure is directed to blends of poly(arylene ether) and polyamide. In particular, the disclosure is directed to blends of poly(arylene ether) and polyamide having low specific volume resistivity.

Poly(arylene ether) resins have been blended with polyamide resins to provide compositions having a wide variety of beneficial properties such as heat resistance, chemical resistance, impact strength, hydrolytic stability and dimensional stability. Blends of poly(arylene ether) and polyamide containing conductive carbon black been successfully painted by electrostatic painting and blends useful for electrostatic painting are commercially available.

Increasingly there is a trend in the painting industry to employ powder coating due to its reduced volatile emissions. A decrease in volatile emissions is desirable for environmental reasons. However, commercially available compatibilized blends of poly(arylene ether) and polyamide, when powder coated, may not result in aesthetically acceptable coated articles.

### BRIEF DESCRIPTION OF THE INVENTION

The afore-mentioned difficulty is addressed by a coated article comprising a powder coating disposed on at least a portion of a surface of a substrate wherein the substrate comprises:
a compatibilized blend of a poly(arylene ether) and a polyamide;
an electrically conductive filler; and
an impact modifier,
and further wherein the substrate has a specific volume resistivity less than or equal to 1×10³ ohm-cm and the powder coating thickness at an interior point of the surface is greater than or equal to 0.6×the average edge powder coating thickness at an edge of the surface.

### BRIEF DESCRIPTION OF THE DRAWINGS

FIGS. 1 and 2 show the picture framing phenomenon.

FIGS. 3 and 4 are schematic representations showing the dimensions of the injection molded part employed in the examples.

FIG. 5 shows, in a comparative way, the results of powder coating in various examples.

FIG. 6 shows exemplary locations of powder thickness measurements.

### DETAILED DESCRIPTION

As mentioned above it is unexpectedly difficult to consistently and evenly powder coat an article comprising an electrically conductive filler and a compatibilized blend of poly(arylene ether) and polyamide. Powder coating of articles made of commercially available compositions comprising an electrically conductive filler and a compatibilized blend of poly(arylene ether) and polyamide results in coated articles having a non-continuous coating, picture framing, or a non-continuous coating with picture framing.

Non-continuous coating is demonstrated by areas of uncovered substrate surrounded by covered (coated) substrate.

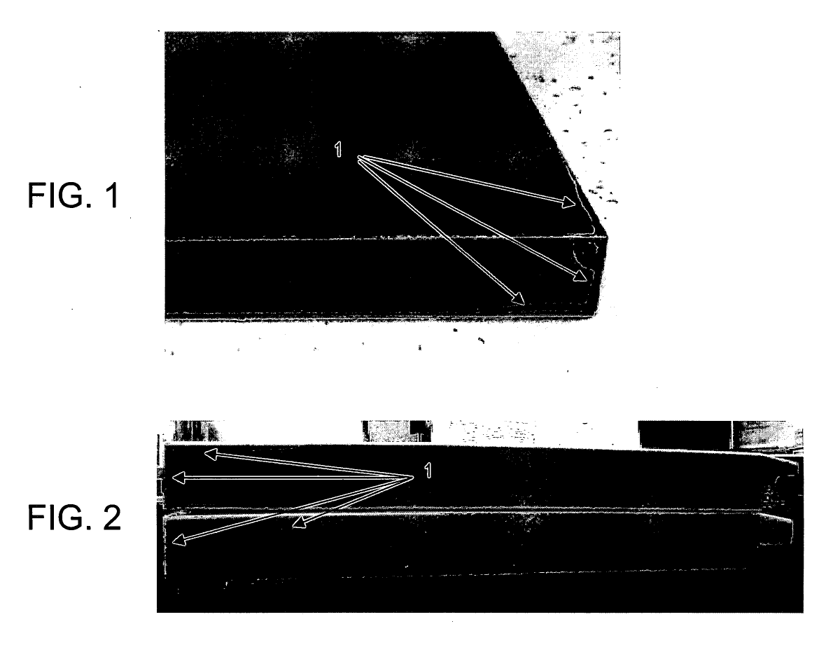

Picture framing is a known phenomenon wherein the thickness of the powder coating at an edge of the article is significantly different than the thickness of the powder coating over an interior area. The change in thickness is typically relatively abrupt and forms a visually detectable change. The picture framing may appear at parts of an edge of an article, over an entire edge of the article or may only be evident nearer to the corners of the article, thus suggesting a picture frame. Picture framing, 1, is shown in FIGS. 1 and 2. The quality of the powder coating is dependent upon the specific volume resistivity, the quantity of electrically conductive filler, distribution of the electrically conductive filler or a combination of two or more of the foregoing.

In one embodiment, picture framing may be defined as when the article is coated on a surface and the powder coating thickness at an interior point of the surface is less than or equal to 0.6×the average edge powder coating thickness for the surface.

The average edge powder coating thickness may be determined by averaging the powder coating thickness at three edge points, A-1, A-2 and B-1. Points A-1, A-2, and B-1 are located 2 to 5 millimeters from an edge of the surface. The distance between point A-1 and point A-2, when determined using a line that is parallel to the edge, is 0.015×the circumference of the surface to 0.030×the circumference of the surface. Similarly the distance between point A-2 and point B-1, when determined using a line that is parallel to the edge, is 0.015×the circumference of the surface to 0.030×the circumference of the surface. When the surface comprises a corner, points A-1, A-2, and B-1 are located no more than 20 millimeters from the corner as determined by measuring parallel to the edge or edges. As used herein edge is defined as an intersection of two sides of a three dimensional object. Corner is defined as the junction of three sides of a three dimensional object.

An interior point of the surface is defined as a location that is greater than or equal to a distance of 0.015×the circumference of the surface away from any edge of the surface.

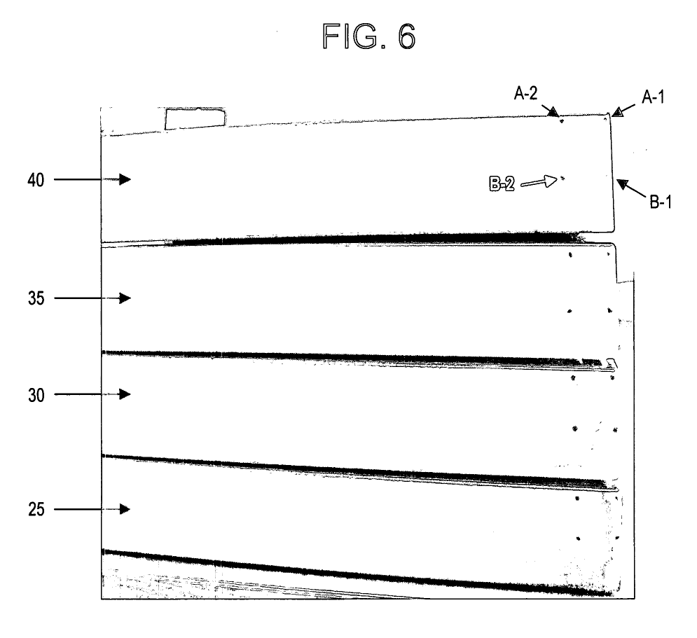

FIG. 6 depicts a powder coated object having three edge points, A-1, A-2, and B-1 and an interior point, B-2. FIG. 6 is discussed in greater detail in the examples.

Typical powder coating thicknesses are 0.038 to 0.178 millimeter. Within this range, the powder coating thickness may be greater than or equal to 0.051 millimeter, or, more specifically, greater than or equal to 0.076 millimeter. Also within this range the powder coating thickness may be less than or equal to 0.152 millimeter, or, more specifically, less than or equal to 0.127 millimeter.

Continuous powder coating coverage is defined as having substantially no gaps or holes detectable to the naked eye, or, more specifically no gaps or holes in the coating that are greater than 1 millimeter in diameter. In one embodiment, the continuous coating is free of gaps or holes that are greater than 0.5 millimeters in diameter. In another embodiment, the continuous coating is free of gaps or holes that are greater than 0.2 millimeters in diameter. In yet another embodiment, the continuous coating is free of gaps or holes that are greater than 0.1 millimeters in diameter.

Specific volume resistivity (SVR) is a measure of the leakage current directly through a material. It is defined as the electrical resistance through a one-centimeter cube of material and is expressed in ohm-cm. The lower the specific volume resistivity of a material, the more conductive the material is. In one embodiment the composition has a specific volume resistivity less than or equal to 1×10³ ohm-cm, or, more specifically, less than or equal to 0.9×10³, or, even more specifically, less than or equal to 0.8×10³. Specific volume resistivity may be determined as described in the Examples.

The terms “a” and “an” herein do not denote a limitation of quantity, but rather denote the presence of at least one of the referenced item. All ranges disclosed herein are inclusive and combinable (e.g., ranges of “up to about 25 wt %, or, more specifically, about 5 wt % to about 20 wt %,” is inclusive of the endpoints and all intermediate values of the ranges of “about 5 wt % to about 25 wt %,” etc.).

As used herein, a “poly(arylene ether)” comprises a plurality of structural units of the formula (I): 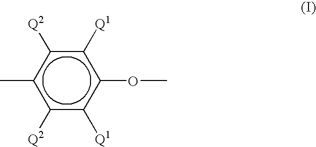
wherein for each structural unit, each Q¹ and each Q² is independently hydrogen; halogen; primary or secondary lower alkyl (e.g., an alkyl containing 1 to 7 carbon atoms); phenyl; haloalkyl; aminoalkyl; alkenylalkyl; alkynylalkyl; aryl; hydrocarbonoxy; or halohydrocarbonoxy wherein at least two carbon atoms separate the halogen and oxygen atoms. In some embodiments, each Q¹ is independently alkyl or phenyl, for example, C₁₋₄ alkyl, and each Q² is independently hydrogen or methyl. The poly(arylene ether) may comprise molecules having aminoalkyl-containing end group(s), typically located in an ortho position to the hydroxy group. Also frequently present are tetramethyl diphenylquinone (TMDQ) end groups, typically obtained from reaction mixtures in which tetramethyl diphenylquinone by-product is present.

The poly(arylene ether) may be in the form of a homopolymer; a copolymer; a graft copolymer; an ionomer; a block copolymer, for example comprising arylene ether units and blocks derived from alkenyl aromatic compounds; as well as combinations comprising at least one of the foregoing. Poly(arylene ether) includes poly(arylene ether) comprising 2,6-dimethyl-1,4-phenylene ether units optionally in combination with 2,3,6-trimethyl-1,4-phenylene ether units.

The poly(arylene ether) may be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

The poly(arylene ether) can have a number average molecular weight of 3,000 to 40,000 grams per mole (g/mol) and/or a weight average molecular weight of about 5,000 to about 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) can have an intrinsic viscosity of 0.10 to 0.60 deciliters per gram (dl/g), or, more specifically, 0.29 to 0.48 dl/g, as measured in chloroform at 25° C. It is possible to utilize a combination of high intrinsic viscosity poly(arylene ether) and a low intrinsic viscosity poly(arylene ether). Determining an exact ratio, when two intrinsic viscosities are used, will depend somewhat on the exact intrinsic viscosities of the poly(arylene ether) used and the ultimate physical properties that are desired.

In one embodiment the poly(arylene ether) has a glass transition temperature (Tg) as determined by differential scanning calorimetry (DSC at 20° C./minute ramp), of 160° C. to 250° C. Within this range the Tg may be greater than or equal to 180° C., or, more specifically, greater than or equal to 200° C. Also within this range the Tg may be less than or equal to 240° C., or, more specifically, less than or equal to 230° C.

The composition comprises poly(arylene ether) in an amount of 15 to 65 weight percent (wt %). Within this range, the poly(arylene ether) can be present in an amount greater than or equal to 25 weight percent, or, more specifically, in an amount greater than or equal to 30 weight percent. Also within this range the poly(arylene ether) may be present in an amount less than or equal to 60 weight percent, or, more specifically, less than or equal to 55 weight percent, or, even more specifically, less than or equal to 50 weight percent. Weight percent is based on the total weight of the uncoated composition.

Polyamide resins, also known as nylons, are characterized by the presence of an amide group (—C(O)NH—), and are described in U.S. Pat. No. 4,970,272. Exemplary polyamide resins include, but are not limited to, nylon-6; nylon-6,6; nylon-4; nylon-4,6; nylon-12; nylon-6,10; nylon 6,9; nylon-6,12; amorphous polyamide resins; nylon 6/6T and nylon 6,6/6T with triamine contents below 0.5 weight percent; nylon 9T and combinations of two or more of the foregoing polyamides. In one embodiment, the polyamide resin comprises nylon 6 and nylon 6,6. When the polyamide comprises a super tough polyamide, i.e. a rubber-toughed polyamide, the composition may or may not contain a separate impact modifier.

Polyamide resins can be obtained by a number of well known processes such as those described in U.S. Pat. Nos. 2,071,250; 2,071,251; 2,130,523; 2,130,948; 2,241,322; 2,312,966; and 2,512,606. Polyamide resins are commercially available from a wide variety of sources.

Polyamide resins having an intrinsic viscosity of up to 400 milliliters per gram (ml/g) can be used, or, more specifically, having a viscosity of 90 to 350 ml/g, or, even more specifically, having a viscosity of 110 to 240 ml/g, as measured in a 0.5 wt % solution in 96 wt % sulfuric acid in accordance with ISO 307.

The polyamide can have a relative viscosity of up to 6, or, more specifically, a relative viscosity of 1.89 to 5.43, or, even more specifically, a relative viscosity of 2.16 to 3.93. Relative viscosity is determined according to DIN 53727 in a 1 wt % solution in 96 wt % sulfuric acid.

In one embodiment, the polyamide resin comprises a polyamide having an amine end group concentration greater than or equal to 35 microequivalents amine end group per gram of polyamide (μeq/g) as determined by titration with HCl. Within this range, the amine end group concentration can be greater than or equal to 40 μeq/g, or, more specifically, greater than or equal to 45 μeq/g. Amine end group content can be determined by dissolving the polyamide in a suitable solvent, optionally with heat. The polyamide solution is titrated with 0.01 Normal hydrochloric acid (HCl) solution using a suitable indication method. The amount of amine end groups is calculated based the volume of HCl solution added to the sample, the volume of HCl used for the blank, the molarity of the HCl solution and the weight of the polyamide sample.

The composition comprises polyamide in an amount of 30 to 85 weight percent. Within this range, the polyamide can be present in an amount greater than or equal to 33 weight percent, or, more specifically, in an amount greater than or equal to 38 weight percent, or, even more specifically, in an amount greater than or equal to 40 weight percent. Also within this range, the polyamide can be present in an amount less than or equal to 80 weight percent, or, more specifically, less than or equal to 75 weight percent, or, even more specifically, less than or equal to 70 weight percent. Weight percent is based on the total weight of the uncoated composition.

When used herein, the expression “compatibilizing agent” refers to polyfunctional compounds which interact with the poly(arylene ether), the polyamide resin, or both. This interaction can be chemical (e.g., grafting) and/or physical (e.g., affecting the surface characteristics of the dispersed phases). In either instance the resulting compatibilized blend of poly(arylene ether) and polyamide appears to exhibit improved compatibility, particularly as evidenced by enhanced impact strength, mold knit line strength and/or elongation. As used herein, the expression “compatibilized blend of poly(arylene ether) and polyamide” refers to those compositions which have been physically and/or chemically compatibilized with an agent as discussed above, as well as those compositions which are physically compatible without such agents, as taught in U.S. Pat. No. 3,379,792.

Examples of the various compatibilizing agents that may be employed include: liquid diene polymers, epoxy compounds, oxidized polyolefin wax, quinones, organosilane compounds, polyfunctional compounds, functionalized poly(arylene ether) and combinations comprising at least one of the foregoing. Compatibilizing agents are further described in U.S. Pat. Nos. 5,132,365 and 6,593,411 as well as U.S. Patent Application No. 2003/0166762.

In one embodiment, the compatibilizing agent comprises a polyfunctional compound. Polyfunctional compounds which may be employed as a compatibilizing agent are of three types. The first type of polyfunctional compounds are those having in the molecule both (a) a carbon-carbon double bond or a carbon-carbon triple bond and (b) at least one carboxylic acid, anhydride, amide, ester, imide, amino, epoxy, orthoester, or hydroxy group. Examples of such polyfunctional compounds include maleic acid; maleic anhydride; fumaric acid; glycidyl acrylate, itaconic acid; aconitic acid; maleimide; maleic hydrazide; reaction products resulting from a diamine and maleic anhydride, maleic acid, fumaric acid, etc.; dichloro maleic anhydride; maleic acid amide; unsaturated dicarboxylic acids (e.g., acrylic acid, butenoic acid, methacrylic acid, t-ethylacrylic acid, pentenoic acid); decenoic acids, undecenoic acids, dodecenoic acids, linoleic acid, etc.); esters, acid amides or anhydrides of the foregoing unsaturated carboxylic acids; unsaturated alcohols (e.g. alkyl alcohol, crotyl alcohol, methyl vinyl carbinol, 4-pentene-1-ol, 1,4-hexadiene-3-ol, 3-butene-1,4-diol, 2,5-dimethyl-3-hexene-2,5-diol and alcohols of the formula CₙH₂ₙ₋₅OH, CₙH₂ₙ₋₇OH and CₙH₂ₙ₋₉OH, wherein n is a positive integer less than or equal to 30); unsaturated amines resulting from replacing from replacing the —OH group(s) of the above unsaturated alcohols with NH₂ groups; functionalized diene polymers and copolymers; and combinations comprising one or more of the foregoing. In one embodiment, the compatibilizing agent comprises maleic anhydride and/or fumaric acid.

The second type of polyfunctional compatibilizing agents are characterized as having both (a) a group represented by the formula (OR) wherein R is hydrogen or an alkyl, aryl, acyl or carbonyl dioxy group and (b) at least two groups each of which may be the same or different selected from carboxylic acid, acid halide, anhydride, acid halide anhydride, ester, orthoester, amide, imido, amino, and various salts thereof. Typical of this group of compatibilizers are the aliphatic polycarboxylic acids, acid esters and acid amides represented by the formula:
(R^{I}O)ₘR(COOR^{II})ₙ(CONR^{III}R^{IV})ₛ
wherein R is a linear or branched chain, saturated aliphatic hydrocarbon having 2 to 20, or, more specifically, 2 to 10, carbon atoms; R¹ is hydrogen or an alkyl, aryl, acyl, or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III} and R^{IV} are independently hydrogen or an alkyl or aryl group having 1 to 10, or, more specifically, 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (OR^{I}) is alpha or beta to a carbonyl group and at least two carbonyl groups are separated by 2 to 6 carbon atoms. Obviously, R^{I}, R^{II}, R^{III}, and R^{IV} cannot be aryl when the respective substituent has less than 6 carbon atoms.

Suitable polycarboxylic acids include, for example, citric acid, malic acid, agaricic acid; including the various commercial forms thereof, such as for example, the anhydrous and hydrated acids; and combinations comprising one or more of the foregoing. In one embodiment, the compatibilizing agent comprises citric acid. Illustrative of esters useful herein include, for example, acetyl citrate, mono- and/or distearyl citrates, and the like. Suitable amides useful herein include, for example, N,N′-diethyl citric acid amide; N-phenyl citric acid amide; N-dodecyl citric acid amide; N,N′-didodecyl citric acid amide; and N-dodecyl malic acid. Derivates include the salts thereof, including the salts with amines and the alkali and alkaline metal salts. Exemplary of suitable salts include calcium malate, calcium citrate, potassium malate, and potassium citrate.

The third type of polyfunctional compatibilizing agents are characterized as having in the molecule both (a) an acid halide group and (b) at least one carboxylic acid, anhydride, ester, epoxy, orthoester, or amide group, preferably a carboxylic acid or anhydride group. Examples of compatibilizers within this group include trimellitic anhydride acid chloride, chloroformyl succinic anhydride, chloro formyl succinic acid, chloroformyl glutaric anhydride, chloroformyl glutaric acid, chloroacetyl succinic anhydride, chloroacetylsuccinic acid, trimellitic acid chloride, and chloroacetyl glutaric acid. In one embodiment, the compatibilizing agent comprises trimellitic anhydride acid chloride.

The foregoing compatibilizing agents may be added directly to the melt blend or pre-reacted with either or both of the poly(arylene ether) and polyamide, as well as with other resinous materials employed in the preparation of the composition. With many of the foregoing compatibilizing agents, particularly the polyfunctional compounds, even greater improvement in compatibility is found when at least a portion of the compatibilizing agent is pre-reacted, either in the melt or in a solution of a suitable solvent, with all or a part of the poly(arylene ether). It is believed that such pre-reacting may cause the compatibilizing agent to react with the polymer and, consequently, functionalize the poly(arylene ether). For example, the poly(arylene ether) may be pre-reacted with maleic anhydride to form an anhydride functionalized polyphenylene ether which has improved compatibility with the polyamide compared to a non-functionalized polyphenylene ether.

Where the compatibilizing agent is employed in the preparation of the compositions, the amount used will be dependent upon the specific compatibilizing agent chosen and the specific polymeric system to which it is added.

Impact modifiers can be block copolymers containing alkenyl aromatic repeating units, for example, A—B diblock copolymers and A—B—A triblock copolymers having of one or two alkenyl aromatic blocks A (blocks having alkenyl aromatic repeating units), which are typically polystyrene blocks, and a rubber block, B, which is typically a polyisoprene or polybutadiene block. The polybutadiene block may be partially or completely hydrogenated. Mixtures of these diblock and triblock copolymers may also be used as well as mixtures of non-hydrogenated copolymers, partially hydrogenated copolymers, fully hydrogenated copolymers and combinations of two or more of the foregoing.

A—B and A—B—A copolymers include, but are not limited to, polystyrene-polybutadiene, polystyrene-poly(ethylene-propylene), polystyrene-polyisoprene, poly(a-methylstyrene)-polybutadiene, polystyrene-polybutadiene-polystyrene (SBS), polystyrene-poly(ethylene-propylene)-polystyrene, polystyrene-polyisoprene-polystyrene and poly(alpha-methylstyrene)-polybutadiene-poly(alpha-methylstyrene), polystyrene-poly(ethylene-propylene-styrene)-polystyrene, and the like. Mixtures of the aforementioned block copolymers are also useful. Such A—B and A—B—A block copolymers are available commercially from a number of sources, including Phillips Petroleum under the trademark SOLPRENE, KRATON Polymers, under the trademark KRATON, Dexco under the trademark VECTOR, Asahi Kasai under the trademark TUFTEC, Total Petrochemicals under the trademarks FINAPRENE and FINACLEAR and Kuraray under the trademark SEPTON.

In one embodiment, the impact modifier comprises polystyrene-poly(ethylene-butylene)-polystyrene, polystyrene-poly(ethylene-propylene) or a combination of the foregoing.

Another type of impact modifier is essentially free of alkenyl aromatic repeating units and comprises one or more moieties selected from the group consisting of carboxylic acid, anhydride, epoxy, oxazoline, and orthoester. Essentially free is defined as having alkenyl aromatic units present in an amount less than 5 weight percent, or, more specifically, less than 3 weight percent, or, even more specifically less than 2 weight percent, based on the total weight of the block copolymer. When the impact modifier comprises a carboxylic acid moiety the carboxylic acid moiety may be neutralized with an ion, preferably a metal ion such as zinc or sodium. It may be an alkylene-alkyl (meth)acrylate copolymer and the alkylene groups may have 2 to 6 carbon atoms and the alkyl group of the alkyl (meth)acrylate may have 1 to 8 carbon atoms. This type of polymer can be prepared by copolymerizing an olefin, for example, ethylene and propylene, with various (meth)acrylate monomers and/or various maleic-based monomers. The term (meth)acrylate refers to both the acrylate as well as the corresponding methacrylate analogue. Included within the term (meth)acrylate monomers are alkyl (meth)acrylate monomers as well as various (meth)acrylate monomers containing at least one of the aforementioned reactive moieties.

In a one embodiment, the copolymer is derived from ethylene, propylene, or mixtures of ethylene and propylene, as the alkylene component; butyl acrylate, hexyl acrylate, or propyl acrylate as well as the corresponding alkyl (methyl)acrylates, for the alkyl (meth)acrylate monomer component, with acrylic acid, maleic anhydride, glycidyl methacrylate or a combination thereof as monomers providing the additional reactive moieties (i.e., carboxylic acid, anhydride, epoxy).

Exemplary first impact modifiers are commercially available from a variety of sources including ELVALOY PTW, SURLYN, and FUSABOND, all of which are available from DuPont.

The aforementioned impact modifiers can be used singly or in combination.

The composition may comprise an impact modifier or a combination of impact modifiers, in an amount of 5 to 25 weight percent. Within this range, the impact modifier may be present in an amount greater than or equal to 7 weight percent, or, more specifically, in an amount greater than or equal to 9 weight percent. Also within this range, the impact modifier may be present in an amount less than or equal to 22 weight percent, or, more specifically, less than or equal to 18 weight percent. Weight percent is based on the total weight of the uncoated composition.

The electrically conductive filler may comprise electrically conductive carbon black, carbon nanotubes, carbon fibers or a combination of two or ore of the foregoing. Electrically conductive carbon blacks are commercially available and are sold under a variety of trade names, including but not limited to S.C.F. (Super Conductive Furnace), E.C.F. (Electric Conductive Furnace), Ketjen Black EC (available from Akzo Co., Ltd.) or acetylene black. In some embodiments the electrically conductive carbon black has an average particle size less than or equal to 200 nanometers (nm), or, more specifically, less than or equal to 100 nm, or, even more specifically, less than or equal to 50 nm. The electrically conductive carbon blacks may also have surface areas greater than 200 square meter per gram (m²/g), or, more specifically, greater than 400 m²/g, or, even more specifically, greater than 1000 m²/g. The electrically conductive carbon black may have a pore volume greater than or equal to 40 cubic centimeters per hundred grams (cm³/100 g), or, more specifically, greater than or equal to 100 cm³/100 g, or, even more specifically, greater than or equal to 150 cm³/100 g, as determined by dibutyl phthalate absorption.

Carbon nanotubes that can be used include single wall carbon nanotubes (SWNTs), multiwall carbon nanotubes (MWNTs), vapor grown carbon fibers (VGCF) and combinations comprising two or more of the foregoing.

Single wall carbon nanotubes (SWNTs) may be produced by laser-evaporation of graphite, carbon arc synthesis or a high-pressure carbon monoxide conversion process (HIPCO) process. These SWNTs generally have a single wall comprising a graphene sheet with outer diameters of 0.7 to 2.4 nanometers (nm). The SWNTs may comprise a mixture of metallic SWNTs and semi-conducting SWNTs. Metallic SWNTs are those that display electrical characteristics similar to metals, while the semi-conducting SWNTs are those that are electrically semi-conducting. In some embodiments it is desirable to have the composition comprise as large a fraction of metallic SWNTs as possible. SWNTs may have aspect ratios of greater than or equal to 5, or, more specifically, greater than or equal to 100, or, even more specifically, greater than or equal to 1000. While the SWNTs are generally closed structures having hemispherical caps at each end of the respective tubes, it is envisioned that SWNTs having a single open end or both open ends may also be used. The SWNTs generally comprise a central portion, which is hollow, but may be filled with amorphous carbon.

In one embodiment the SWNTs comprise metallic nanotubes in an amount of greater than or equal to 1 wt %, or, more specifically, greater than or equal to 20 wt %, or, more specifically, greater than or equal to 30 wt %, or, even more specifically greater than or equal to 50 wt %, or, even more specifically, greater than or equal to 99.9 wt % of the total weight of the SWNTs.

In one embodiment the SWNTs comprise semi-conducting nanotubes in an amount of greater than or equal to 1 wt %, or, more specifically, greater than or equal to 20 wt %, or, more specifically, greater than or equal to 30 wt %, or, even more specifically, greater than or equal to 50 wt %, or, even more specifically, greater than or equal to 99.9 wt % of the total weight of the SWNTs.

MWNTs may be produced by processes such as laser ablation and carbon arc synthesis. MWNTs have at least two graphene layers bound around an inner hollow core. Hemispherical caps generally close both ends of the MWNTs, but it is also possible to use MWNTs having only one hemispherical cap or MWNTs which are devoid of both caps. MWNTs generally have diameters of 2 to 50 nm. Within this range, the MWNTs may have an average diameter less than or equal to 40, or, more specifically, less than or equal to 30, or, even more specifically less than or equal to 20 nm. MWNTs may have an average aspect ratio greater than or equal to 5, or, more specifically, greater than or equal to 100, or, even more specifically greater than or equal to 1000.

Vapor grown carbon fibers (VGCF) are generally manufactured in a chemical vapor deposition process. VGCF having “tree-ring” or “fishbone” structures may be grown from hydrocarbons in the vapor phase, in the presence of particulate metal catalysts at moderate temperatures, i.e., 800 to 1500° C. In the “tree-ring” structure a multiplicity of substantially graphitic sheets are coaxially arranged about the core. In the “fishbone” structure, the fibers are characterized by graphite layers extending from the axis of the hollow core.

VGCF having diameters of 3.5 to 2000 nanometers (nm) and aspect ratios greater than or equal to 5 may be used. VGCF may have diameters of 3.5 to 500 nm, or, more specifically 3.5 to 100 nm, or, even more specifically 3.5 to 50 nm. VGCF may have an average aspect ratios greater than or equal to 100, or, more specifically, greater than or equal to 1000.

Various types of conductive carbon fibers may also be used in the composition. Carbon fibers are generally classified according to their diameter, morphology, and degree of graphitization (morphology and degree of graphitization being interrelated). These characteristics are presently determined by the method used to synthesize the carbon fiber. For example, carbon fibers having diameters down to 5 micrometers, and graphene ribbons parallel to the fiber axis (in radial, planar, or circumferential arrangements) are produced commercially by pyrolysis of organic precursors in fibrous form, including phenolics, polyacrylonitrile (PAN), or pitch.

The carbon fibers generally have a diameter of greater than or equal to 1,000 nanometers (1 micrometer) to 30 micrometers. Within this range fibers having sizes of greater than or equal to 2, or, more specifically, greater than or equal to 3, or, more specifically greater than or equal to 4 micrometers may be used. Also within this range fibers having diameters of less than or equal to 25, or, more specifically, less than or equal to 15, or, even more specifically less than or equal to 11 micrometers may be used.

The composition comprises a sufficient amount of electrically conductive filler to achieve a specific volume resistivity less than or equal to 1×10³ ohm-cm. For example, the composition may comprise electrically conductive carbon black, carbon fibers, carbon nanotubes, or a combination of two or more of the foregoing electrically conductive carbon fillers in an amount greater than or equal to 2.1 weight percent. Within this range, the electrically conductive carbon filler may be present in an amount greater than or equal to 2.2 weight percent, or, more specifically, in an amount greater than or equal to 2.3 weight percent. The electrically conductive carbon filler may be present in an amount less than or equal to 10 weight percent, or, more specifically, less than or equal to 5 weight percent. Weight percent is based on the total weight of the uncoated composition.

The composition can be prepared melt mixing or a combination of dry blending and melt mixing. Melt mixing can be performed in single or twin screw type extruders or similar mixing devices which can apply a shear to the components.

All of the ingredients may be added initially to the processing system. In some embodiments, the poly(arylene ether) may be precompounded with the compatibilizing agent. Additionally other ingredients such as an impact modifier, additives, a portion of the polyamide or a combination of one or more of the foregoing may be precompounded with the compatibilizing agent and poly(arylene ether). In one embodiment, the poly(arylene ether) is precompounded with the compatibilizing agent to form a functionalized poly(arylene ether). The functionalized poly(arylene ether) is then compounded with the other ingredients. In another embodiment the poly(arylene ether), compatibilizing agent, impact modifier, optional additives are compounded to form a first material and the polyamide is then compounded with the first material.

When using an extruder, all or part of the polyamide may be fed through a port downstream. While separate extruders may be used in the processing, preparations in a single extruder having multiple feed ports along its length to accommodate the addition of the various components simplifies the process. It is often advantageous to apply a vacuum to the melt through one or more vent ports in the extruder to remove volatile impurities in the composition.

The electrically conductive filler may be added by itself, with other ingredients (optionally as a dry blend) or as part of a masterbatch. In one embodiment, the electrically conductive filler can be part of a masterbatch comprising polyamide. The electrically conductive filler (independently or as a masterbatch) may be added with the poly(arylene ether), with the polyamide (the second portion when two portions are employed), or after the addition of the polyamide (the second portion when two portions are employed).

In one embodiment the composition comprises the reaction product of poly(arylene ether); polyamide; electrically conductive filler; compatibilizing agent; and impact modifier. As used herein a reaction product is defined as the product resulting from the reaction of two or more of the foregoing components under the conditions employed to form the composition, for example during compounding or high shear mixing.

The composition may further comprise effective amounts of at least one additive selected from the group consisting of anti-oxidants, flame retardants, drip retardants, dyes, pigments, colorants, stabilizers, small particle mineral such as clay, mica, and talc, antistatic agents, plasticizers, lubricants, and mixtures thereof. These additives are known in the art, as are their effective levels and methods of incorporation. Effective amounts of the additives vary widely, but they are usually present in an amount up to about 50% or more by weight, based on the weight of the uncoated composition.

After the composition is formed it is typically formed into strands which are cut to form pellets. The strand diameter and the pellet length are typically chosen to prevent or reduce the production of fines (particles that have a volume less than or equal to 50% of the pellet) and for maximum efficiency in subsequent processing such as profile extrusion. An exemplary pellet length is 1 to 5 millimeters and an exemplary pellet diameter is 1 to 5 millimeters.

The pellets can exhibit hygroscopic properties. Once water is absorbed it can be difficult to remove. Typically drying is employed but extended drying can affect the performance of the composition. Similarly water, outside the range of 0.01-0.1%, or, more specifically, 0.02-0.07% moisture by weight, can hinder the use of the composition in some applications. It is advantageous to protect the composition from ambient moisture. In one embodiment the pellets, once cooled to a temperature of 50° C. to 110° C., are packaged in a container comprising a moisture barrier layer, e.g., a mono-layer of polypropylene resin free of a metal layer wherein the container has a wall thickness of 0.25 millimeters to 0.60 millimeters. The pellets, once cooled to 50 to 110° C. can also be packaged in foiled lined containers such as foil lined boxes and foil lined bags.

The composition may be converted to articles using film extrusion, sheet extrusion, profile extrusion, extrusion molding, compression molding, injection molding, and blow molding. Film and sheet extrusion processes may include and are not limited to melt casting, blown film extrusion and calendaring. Co-extrusion and lamination processes may be employed to form composite multi-layer films or sheets. When the article comprises a multi-layer film or sheet, powder coating is performed on the surface comprising the compatibilized blend of poly(arylene ether), polyamide, impact modifier, and electrically conductive filler as described above.

Single or multiple layers of coatings may further be applied to the single or multi-layer substrates to impart additional properties such as scratch resistance, ultra violet light resistance, aesthetic appeal, etc. Coatings are applied by standard powder coating application techniques.

In powder coating, a powdered resin is applied to the substrate and then the substrate and powder are heated so that the powder melts and when subsequently cooled, forms a solid continuous coating on the substrate. In most powder spraying applications, an electrostatic charge is applied to the sprayed powder which is directed toward a grounded substrate so as to increase the quantity of powder which attaches to the substrate and to assist in retaining the powder on the substrate. In some embodiments the substrate is heated prior to powder coating. The substrate may also be pre treated to remove any residues from molding, handling, or both. In addition, the substrate may optionally be treated with a primer over at least a portion of the substrate surface prior to powder coating. The oversprayed powder which is not deposited on the substrate can be collected. The recovered, oversprayed powder can be saved for future use, or can be immediately recycled to powder spray guns associated with the powder spray.

The films and sheets described above may further be thermoplastically processed into shaped articles via forming and molding processes including but not limited to thermoforming, vacuum forming, pressure forming, injection molding and compression molding. Multi-layered shaped articles may also be formed by injection molding a thermoplastic resin onto a single or multi-layer film or sheet substrate as described below:
1. Providing a single or multi-layer thermoplastic substrate having optionally one or more colors on the surface, for instance, using screen printing or a transfer dye.
2. Conforming the substrate to a mold configuration such as by forming and trimming a substrate into a three dimensional shape and fitting the substrate into a mold having a surface which matches the three dimensional shape of the substrate.
3. Injecting a thermoplastic resin into the mold cavity behind the substrate to (i) produce a one-piece permanently bonded three-dimensional product or (ii) transfer a pattern or aesthetic effect from a printed substrate to the injected resin and remove the printed substrate, thus imparting the aesthetic effect to the molded resin.

Those skilled in the art will also appreciate that common curing and surface modification processes including and not limited to heat-setting, texturing, embossing, corona treatment, flame treatment, plasma treatment and vacuum deposition may further be applied to the above articles to alter surface appearances and impart additional functionalities to the articles.

Accordingly, another embodiment relates to articles and sheets prepared from the compositions above.

Exemplary articles include all or portions of the following articles: furniture, partitions, containers, vehicle interiors including rail cars, subway cars, busses, trolley cars, airplanes, automobiles, and recreational vehicles, exterior vehicle accessories such as roof rails, appliances, cookware, electronics, analytical equipment, window frames, wire conduit, flooring, infant furniture and equipment, telecommunications equipment, antistatic packaging for electronics equipment and parts, health care articles such as hospital beds and dentist chairs, exercise equipment, motor covers, display covers, business equipment parts and covers, light covers, signage, air handling equipment and covers, automotive underhood parts.

In one embodiment the coated article comprises a powder coating disposed on at least a portion of a surface of a substrate wherein the substrate comprises:
a compatibilized blend of a poly(arylene ether) and a polyamide;
an electrically conductive filler; and
an impact modifier,
   and further wherein the substrate has a specific volume resistivity less than or equal to 1×10³ ohm-cm and further wherein the powder coating thickness at an interior point of the surface is greater than or equal to 0.6×the average edge powder coating thickness at an edge of the surface.

In another embodiment the coated article comprises a powder coating disposed on at least a portion of a surface of a substrate wherein the substrate comprises:
a compatibilized blend of a poly(arylene ether) and a polyamide;
an electrically conductive carbon black in an amount greater than or equal to 2.1 weight percent based on the total weight of the uncoated substrate; and
an impact modifier,
   and the powder coating thickness at an interior point of the surface is greater than or equal to 0.6×the average edge powder coating thickness at an edge of the surface.

In one embodiment the coated article comprises a powder coating disposed on at least a portion of a surface of a substrate wherein the substrate comprises:
a compatibilized blend of a poly(arylene ether) and a polyamide;
an electrically conductive filler; and
an impact modifier,
   and further wherein the substrate has a specific volume resistivity less than or equal to 1×10³ ohm-cm and the powder coating thickness varies by less than or equal to 40% of the average powder coating thickness over the surface.

In another embodiment the coated article comprises a powder coating disposed on at least a portion of a substrate wherein the substrate comprises:
a compatibilized blend of a poly(arylene ether) and a polyamide;
an electrically conductive filler; and
an impact modifier,
   and further wherein the substrate has a specific volume resistivity less than or equal to 1×10³ ohm-cm and the coated article has a continuous powder coating coverage and is free of picture framing visible to the unaided eye. The phrase “unaided eye” does not exclude the use of corrective lenses but does exclude non-corrective magnification.

The following non-limiting examples further illustrate the various embodiments described herein.

### EXAMPLES

The examples employed the materials listed in Table 1. The amounts employed in the Examples are in weight percent based on the total weight of the composition, unless otherwise stated. Additives in an amount of 0.7 weight percent were also employed.

TABLE 1

| Material | Description/Supplier |
|---|---|
| PPO | Poly(2,6-dimethyl-1,4-phenylene ether) having an |
| | intrinsic viscosity of 0.40 dl/g as determined in |
| | chloroform at 25° C., which is commercially available |
| | from GE Advanced Materials. |
| KG 1701 | Polystyrene-poly(ethylene-propylene) commercially |
| | available from KRATON Polymers under the tradename |
| | KRATON G 1701. |
| KG 1651 | Polystyrene-poly(ethylene-butylene)-polystyrene |
| | commercially available from KRATON Polymers under |
| | the tradename KRATON G 1651. |
| CA | Citric Acid |
| PA 6 | Polyamide 6 having an amine end group content of |
| | 100 μeq/kg and commercially available from Rhodia |
| | under the tradename TECHNYL ASAN 27/32-35 LC. |
| PA 6,6 | Polyamide 6,6 commercially available from Rhodia under |
| | the tradename TECHNYL 24 FE 1. |
| CCB MB | A masterbatch of conductive carbon black in polyamide |
| | 6,6. The masterbatch comprised 8 weight percent |
| | conductive carbon black, based on the total weight |
| | of the masterbatch. |

The examples were made by dry blending the PPO, KG 1701, KG 1651, citric acid, and additives and adding the dry blend to the feedthroat of a Werner and Pfleiderer 30 millimeter extruder. PA 6, when present, was added upstream in a second feeder. PA 6,6 and the CCB masterbatch were added at downstream feeder. The screw ran at 350 rotations per minute and the feed rate was 50 pounds per hour. The material was extruded as pellets and then molded as described below. The temperature profile of the extruder is shown in Table 2. Temperature is in degrees Celsius. The composition of the examples is shown in Table 3. The amount of conductive carbon black was calculated from the amount of conductive carbon black employed in the masterbatch and the amount of masterbatch employed in the example and is shown in the column “Neat CCB”.

TABLE 2

| 1 | 2 | 3 | 4 | 5 | 6 | 7 | 8 | 9 | 10 | Die |
|---|---|---|---|---|---|---|---|---|---|---|
| 260 | 280 | 280 | 290 | 290 | 290 | 290 | 290 | 290 | 290 | 290 |

TABLE 3

| | | | KG | | | PA | CCB | Neat |
|---|---|---|---|---|---|---|---|---|
| Ex. | PPO | KG1701 | 1651 | CA | PA 6 | 6,6 | MB | CCB |
| 1* | 33.93 | 7.96 | 6.96 | 0.7 | — | 32.24 | 17.50 | 1.4 |
| 2* | 33.93 | 7.96 | 6.96 | 0.7 | — | 28.49 | 21.25 | 1.7 |
| 3* | 33.93 | 7.96 | 6.96 | 0.7 | — | 24.87 | 24.87 | 2.0 |
| 4 | 33.93 | 7.96 | 6.96 | 0.7 | — | 20.94 | 28.80 | 2.3 |
| 5* | 33.93 | 7.96 | 6.96 | 0.7 | 9.95 | 22.30 | 17.50 | 1.4 |
| 6* | 33.93 | 7.96 | 6.96 | 0.7 | 9.95 | 18.54 | 21.25 | 1.7 |
| 7* | 33.93 | 7.96 | 6.96 | 0.7 | 9.95 | 14.92 | 24.87 | 2.0 |
| 8 | 33.93 | 7.96 | 6.96 | 0.7 | 9.95 | 11.00 | 28.80 | 2.3 |

*Comparative Example

The examples were tested for specific volume resistivity (SVR). The compositions were molded into ISO tensile bars. The bars were scored and then submerged in liquid nitrogen for approximately 5 minutes. As soon as the bars were removed from the liquid nitrogen they were snapped at the score marks. The ends were painted with electrically conductive silver paint and dried. Resistance was measured by placing the probes of a handheld multimeter on each painted end of the bar. The resistivity was calculated as the resistance (in Ohms)×bar width (in centimeters (cm))×bar depth (cm) divided by the bar length (cm). Data is shown in Table 4.

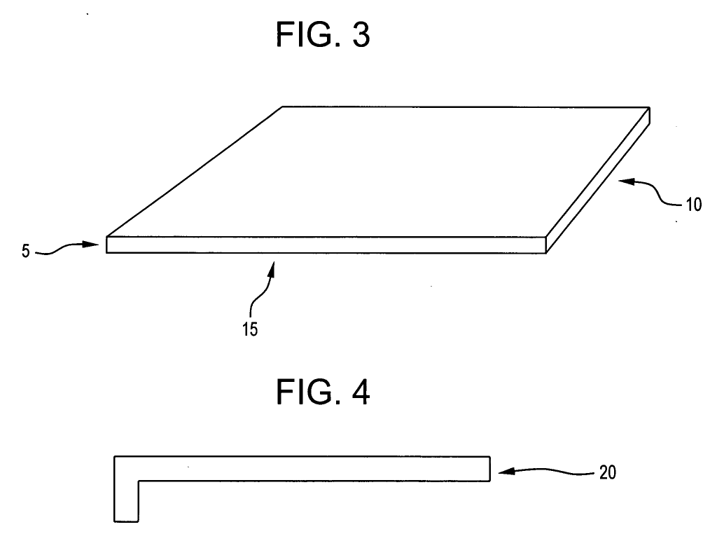

The examples were also rated, on a visual basis, for picture framing on an injection molded article. The injection molded article, as shown schematically in FIG. 3, had a width, 15, of 352 millimeters, a height, 5, of 33 millimeters, a length, 10, of 336 millimeters. FIG. 4 is a cross section of the article having a wall thickness, 20, of 3 millimeters. The articles were powder coated using a Nordson spray booth at 24° C. and 50% relative humidity and polyester epoxy hybrid powder coating from IVC Industrial Coatings. Dry off temperatures were 185-199° C. for 20 minutes and cure temperatures were 185-199° C. for 20 minutes. Picture framing I was visually rated for severity at a corner location. Rating was based on a scale of 1 to 10 with 1 is the worst and 10 is the best. Picture framing II was rated by attribute where N (for None) indicated no visually detectable picture framing and Y (for Yes) indicated picture framing was present. Paint coverage was also visually evaluated as either I (for Insufficient) or C (for Complete). Data is shown in Table 4.

TABLE 4

| | Neat | Picture | Picture | Paint | |
|---|---|---|---|---|---|
| Ex. | CCB | Framing I | Framing II | Coverage | SVR |
| 1* | 1.4 | 8 | Y | I | 45.9 |
| 2* | 1.7 | 5 | Y | I | 11.1 |
| 3* | 2.0 | 3 | Y | C | 1.4 |
| 4 | 2.3 | 10 | N | C | 0.6 |
| 5* | 1.4 | 8 | Y | I | 803.1 |
| 6* | 1.7 | 4 | Y | I | 7.9 |
| 7* | 2.0 | 2 | Y | C | 1.7 |
| 8 | 2.3 | 10 | N | C | 0.8 |

*Comparative Example

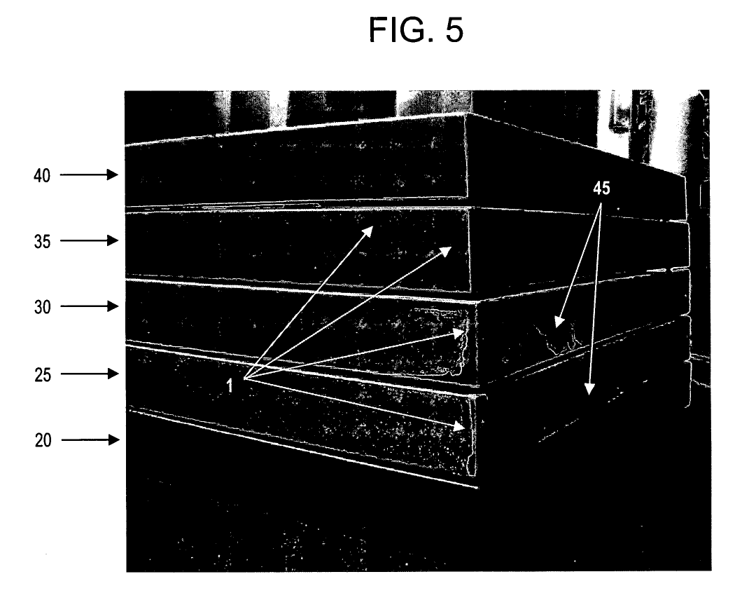

FIG. 5 shows an uncoated part, 20, a coated part, 25, according to Example 1, a coated part, 30, according to Example 2, a coated part, 35, according to Example 3, and a coated part, 40, according to Example 4. Picture framing, 1, and discontinuous coverage, 45, is also shown. Surprisingly, increasing conductive carbon black loading demonstrates an inverse relationship with picture framing rating until a conductive carbon black loading of greater than 2.0 weight percent and an SVR less than 1.0×10³ ohm-cm is achieved as shown by Table 4 and FIG. 5.

FIG. 6 shows an a coated part, 25, according to Example 1, a coated part, 30, according to Example 2, a coated part, 35, according to Example 3, and a coated part, 40, according to Example 4. FIG. 6 also shows the locations of the four points at which the thickness of the powder coating was measured. The article was cut with a band saw to cross section the article on the line formed by points A—I and A-2 as well as on line formed by B-1 and B-2. Sections were taken with a diamond knife from the cross sectioned piece at A-1, A-2, B-1, and B-2. A-1 was located 3.175 millimeters from the two closest edges. A-2 was located 3.175 from one edge and 14 millimeters from the adjoining edge. B-1 was located 3.175 millimeters from one edge and 19 millimeters from the adjoining edge. B-2 was located 14 millimeters from one edge and 19 millimeters from the adjoining edge. The sections were viewed with an Olympus BX60 compound light microscope using reflected light. An Optronics microfire digital camera mounted to the light microscope with Optronics Pictureframe capture software was used to capture the digital optical micrographs of the powder coated layer/substrate sections. Image-pro plus version 4.5 image analysis software was used to measure the powder coating thickness from the captured digital optical micrographs. Data is shown in Table 5. The powder coating thickness values are in micrometers.

TABLE 5

| | | | | | | Ratio of B-2 to |
|---|---|---|---|---|---|---|
| | | | | | Average of | Average of |
| | Thickness | Thickness | Thickness | Thickness | A-1, A-2 | A-1, A-2, |
| | at A-1 | at A-2 | at B-1 | at B-2 | and B-1 | and B-1 |
| 1* | 72.0 | 14.4 | 42.1 | 12.6 | 42.8 | 29% |
| 2* | 59.8 | 86.1 | 58.7 | 19.2 | 68.2 | 28% |
| 3* | 137.8 | 117.8 | 104.5 | 58.4 | 120.0 | 49% |
| 4 | 56.1 | 39.1 | 45.8 | 33.2 | 47.0 | 71% |

*Comparative Example

Surprisingly, increasing conductive carbon black loading demonstrates an inverse relationship with picture framing rating until a conductive carbon black loading of greater than 2.0 weight percent and an SVR less than 1.0×10³ ohm-cm is achieved as shown by Table 5 and FIG. 7. Example 4, when injection molded into an article and powder coated, has a powder coating thickness at an interior area that is 71% of the average edge powder coating thickness and picture framing is not visible to the unaided eye.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A coated article comprising a powder coating disposed on at least a portion of a surface of a substrate wherein the substrate comprises:
a compatibilized blend of a poly(arylene ether) and a polyamide;
an electrically conductive filler; and
an impact modifier,
and further wherein the substrate has a specific volume resistivity less than or equal to 1×10³ ohm-cm and the powder coating thickness at an interior point of the surface is greater than or equal to 0.6×the average edge powder coating thickness at an edge of the surface.

2. The coated article of claim 1 wherein the average edge powder coating thickness is be determined by
averaging the powder coating thickness at three edge points, A-1, A-2 and B-1 wherein
points A-1, A-2, and B-1 are located 2 to 5 millimeters from an edge of the surface,
the distance between point A-1 and point A-2, when determined using a line that is parallel to the edge, is 0.015×the circumference of the surface to 0.030×the circumference of the surface,
the distance between point A-2 and point B-1, when determined using a line that is parallel to the edge, is 0.015×the circumference of the surface to 0.030×the circumference of the surface, and
when the surface comprises a corner, points A-1, A-2, and B-1 are located no more than 20 millimeters from the corner as determined by measuring parallel to the edge or edges
and further wherein an interior point of the surface is defined as a location that is greater than or equal to a distance of 0.015×the circumference of the surface away from any edge of the surface.

3. The coated article of claim 1 wherein the powder coating is continuous.

4. The coated article of claim 1 wherein the substrate has a specific volume resistivity less than or equal to 0.9×10³ ohm-cm.

5. The coated article of claim 1 wherein the poly(arylene ether) has a glass transition temperature of 160° C. to 250° C. as determined by differential scanning calorimetry at 20° C./minute ramp.

6. The coated article of claim 1 wherein the substrate comprises 15 to 65 weight percent poly(arylene ether), 30 to 85 weight percent polyamide, 5 to 25 weight percent impact modifier, wherein all weight percents are based on the total weight of the uncoated substrate.

7. The coated article of claim 1 wherein the electrically conductive carbon filler is present in an amount of 2.1 weight percent to 10 weight percent based on the total weight of the uncoated substrate.

8. The coated article of claim 1, wherein the compatibilized blend of a poly(arylene ether) and a polyamide is the reaction product of a poly(arylene ether), a polyamide and a compatibilizing agent.

9. The coated article of claim 8, wherein the compatibilizing agent is selected from the group consisting of citric acid, maleic anhydride, fumaric acid, and combinations comprising one or more of the foregoing compatibilizing agents.

10. A coated article comprises a powder coating disposed on at least a portion of a surface of a substrate wherein the substrate comprises:
a compatibilized blend of a poly(arylene ether) and a polyamide;
an electrically conductive carbon black in an amount greater than or equal to 2.1 weight percent based on the total weight of the uncoated substrate; and
an impact modifier,
and the powder coating thickness at an interior point of the surface is greater than or equal to 0.6×the average edge powder coating thickness at an edge of the surface.

11. A coated article comprises a powder coating disposed on at least a portion of a surface of a substrate wherein the substrate comprises:
a compatibilized blend of a poly(arylene ether) and a polyamide;
an electrically conductive filler; and
an impact modifier,
and further wherein the substrate has a specific volume resistivity less than or equal to 1×10³ ohm-cm and further wherein the substrate has a specific volume resistivity less than or equal to 1×10³ ohm-cm and the powder coating thickness varies by less than or equal to 40% of the average powder coating thickness over the surface.

12. A coated article comprises a powder coating disposed on at least a portion of a substrate wherein the substrate comprises:
a compatibilized blend of a poly(arylene ether) and a polyamide;
an electrically conductive filler; and
an impact modifier,
and further wherein the substrate has a specific volume resistivity less than or equal to 1×10³ ohm-cm and the coated article has a continuous powder coating coverage and is free of picture framing visible to the unaided eye
